(19) United States
(12) Patent Application Publication
(10) Pub. No.: US 2014/0332314 A1
(43) Pub. Date: Nov. 13, 2014

(54) BOOM LIFT PROVIDED WITH A CONTROL CONSOLE

(71) Applicant: Haulotte Group, L'Home (FR)

(72) Inventors: Christophe Carrillo, Saint Martin La Plaine (FR); Gaëtan Godineau, Orlienas (FR); Slaheddine Beji, Vienne (FR)

(73) Assignee: Haulott Group, L'Home (FR)

(21) Appl. No.: 14/366,862

(22) PCT Filed: Dec. 18, 2012
(86) PCT No.: PCT/EP2012/076020

§ 371 Date: Jun. 19, 2014

(30) Foreign Application Priority Data
Dec. 19, 2011 (FR) 1161940

(51) Int. Cl. B66F 11/04; B66F 17/00

(52) U.S. Cl. CPC B66F 11/04; B66F 17/006
USPC 182/19; 182/69.4

(57) ABSTRACT

The invention relates to a boom lift, including a frame provided with a means for moving on the surface of the ground, a platform, a means for lifting the platform relative to the frame, and a console (8) for controlling, from said platform, the moving means and/or the lifting means. The control console (8) includes two half-consoles (81, 82), each of which is provided with at least one lever (811, 821) or button (812, 822, 813, 823) for manually controlling the boom lift, and arranged on either side of an operator on the platform in a position for using the levers or button with both hands, while the space (V8) located opposite the operator in said position has no control levers or buttons.

The invention relates to a boom lift comprising, inter alia, a platform and a console for controlling, from that platform, means for moving the boom on the ground and/or means for elevating the platform relative to a frame of the lift.

In the known lifts, a control console is generally made up of a parallelepiped housing that bears buttons and/or control levers on its upper face that are designed to be actuated by an operator. This housing is most often fastened at the upper part of a railing of the platform, on a side thereof turned toward the front in a main movement direction of the lift.

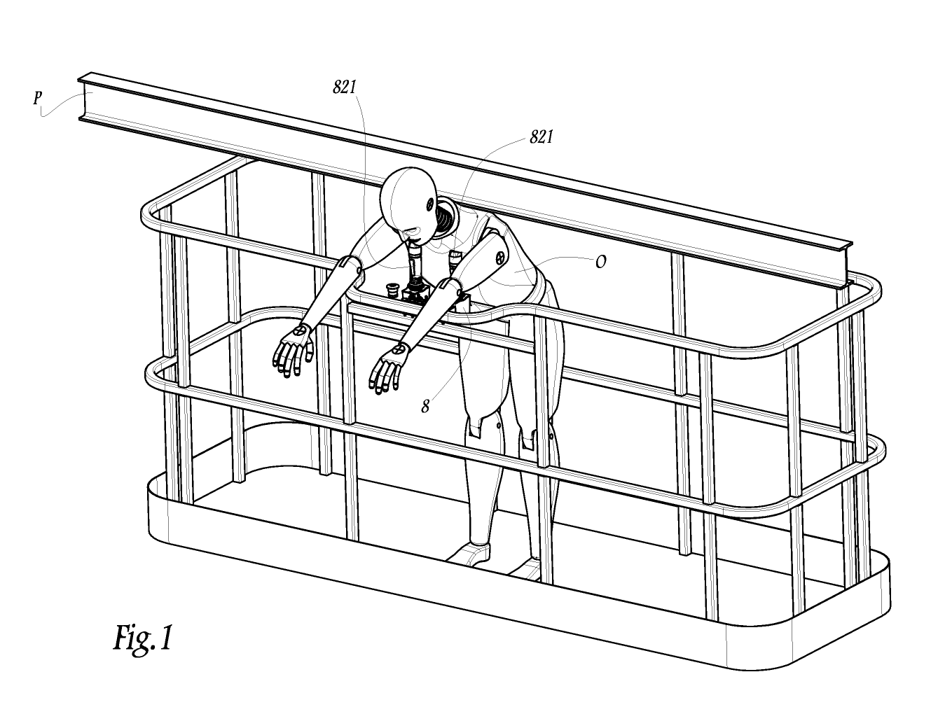

With this type of equipment, there is a risk that, when the lift moves backward, the operator facing the control console may not see an obstacle arrive, his back being turned to it. This then results in the configuration of FIG. 1 where the obstacle, in this case the beam P, pushes and compresses the operator O against the control console 8, with a high risk of injury. In that case, the pressure of the operator's body on the control console may even exert a force on one of the levers 821 or buttons of that console tending to maintain the backward movement of the lift, thereby increasing the crushing of the operator.

In this respect, when he controls the lift using the control console, the operator O is a short distance from that console such that, if a beam P strikes him during a backward movement, he generally does not have time to stop the movement of the lift before being firmly pressed against that console.

To offset this problem, it is known from WO-A-2009037429 or EP-A-2 327 656 to provide a control console with crushing sensors that make it possible to react to the pressure of an operator's body pressed against the console by an obstacle. This equipment cannot prevent the operator from being injured, since it only reacts after the impact of the operator's body against the control console.

The invention more particularly aims to resolve these drawbacks by proposing a new boom lift that improves operator safety.

To that end, the invention relates to a boom lift comprising a frame equipped with means for moving on the surface of the ground, a platform, means for elevating the platform relative to the frame and a console for controlling the movement means and/or elevation means from that platform. According to the invention, the control console comprises two half-consoles each equipped with at least one control lever or button for controlling the lift manually and positioned on either side of an operator present on the platform in a position for using those levers or buttons with both of his hands, while the space positioned across from the operator in that position has no lever and control button.

Owing to the invention, the central space positioned across from the operator when he uses the control console can be freed of any obstacle that may injure him, in particular levers or buttons protruding relative to the surface of a housing of the control console. The positioning of the half-consoles on either side of the operator is ergonomic inasmuch as these half-consoles are approximately aligned with the operator's forearm. Thus, in the event of an impact with an obstacle occurring from behind the operator, he is pushed back toward the central space, which has a lower risk of injuring him than the consoles of the state of the art.

According to advantageous, but optional aspects of the invention, such a list may comprise one or more of the following features in any technically allowable combination:
The half-consoles are mounted on the lift independently of one another.
At least one half-console, preferably both half-consoles, is or are mounted pivotably relative to the platform.
The half-console(s) is or are pivoting, each around a vertical axis, relative to the platform.
The lift is equipped with at least one detector which, when the half-console abuts during pivoting, emits a signal to activate emergency stop means of the lift.
Alternatively, the two half-consoles are connected to each other by a central bracket whereof the width, measured in a horizontal direction perpendicular to a straight line connecting the two half-consoles, is smaller than the size of those half-consoles in that direction. This bracket advantageously faces the operator present on the platform in the position for using the levers or buttons of the half-consoles with both of his hands, and it is equipped with information devices with no protruding parts.
The half-consoles are mounted on a railing of the platform.
When the half-consoles are mounted independently, each half-console can be mounted and articulated on a vertical upright of the railing.
The height of at least one of the half-consoles can be adjusted relative to the platform.

The invention will be better understood, and other advantages thereof will appear more clearly, in light of the following description of two embodiments of a lift according to its principle, provided solely as an example and done in reference to the appended drawings, in which:

FIG. 1 is a diagrammatic illustration of an impact configuration with a lift of the prior art,

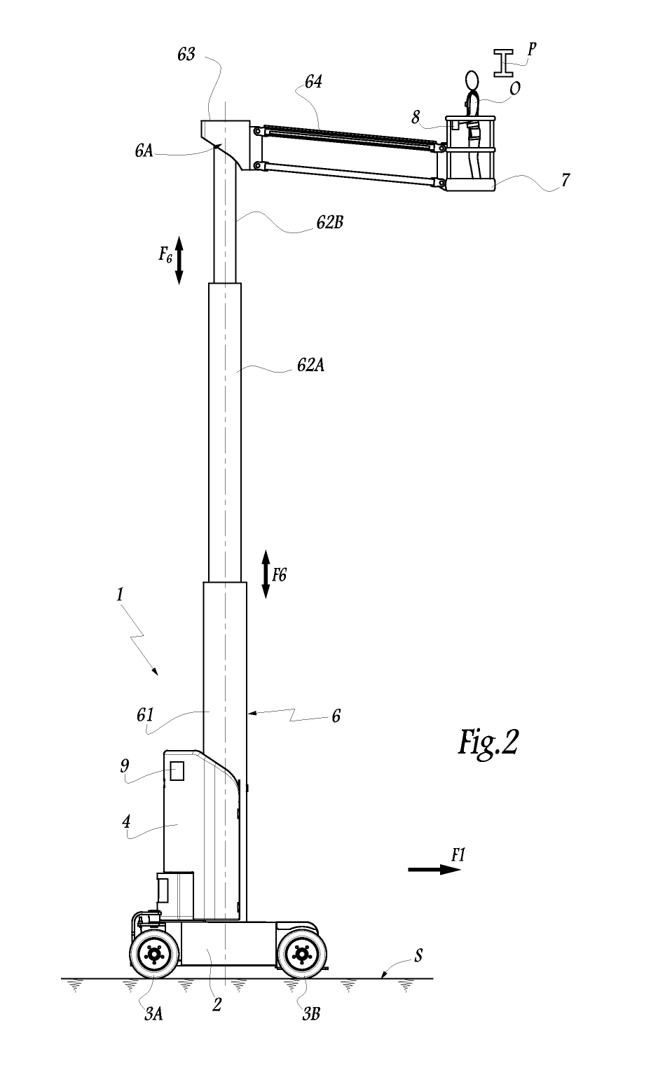

FIG. 2 is an elevation block diagram of a lift according to the invention,

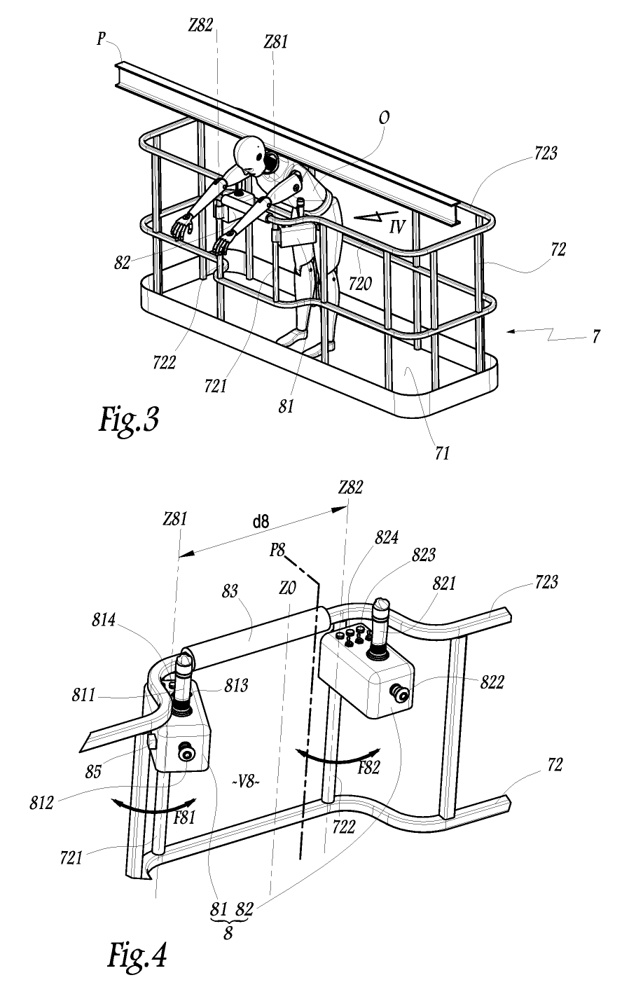

FIG. 3 is a view similar to FIG. 1, but on a smaller scale, in the context of the use of the lift of FIG. 2,

FIG. 4 is a perspective view of the console of the lift of FIGS. 2 and 3 in the direction of arrow IV in FIG. 3,

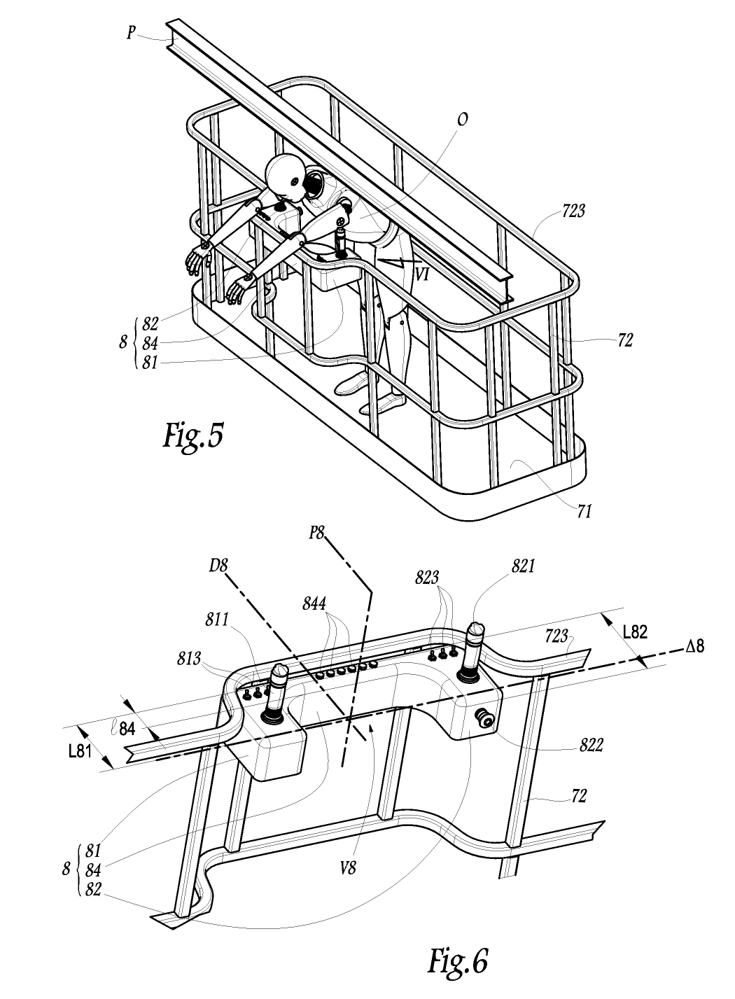

FIG. 5 is a view similar to FIG. 3 for a lift according to a second embodiment of the invention, and

FIG. 6 is a view similar to FIG. 4, in the direction of arrow VI in FIG. 5, for the lift of FIG. 5.

The lift 1 shown in FIG. 2 is equipped with a frame 2 resting on a surface of the floor S using four wheels, two of which are visible in this figure with references 3A and 3B. The frame 2 bears a motor unit 4 with which a mast 6 comprising a barrel 61 is associated, as well as two parts 62A and 62B telescoping relative to one another and relative to the barrel 61. The possibility of vertical extension of the mast 6 is illustrated by the double arrows F6. The mast could have more than two parts 62A and 62B or, on the contrary, only one such part.

In the upper part 6A of the mast 6, a stirrup 63 is provided on which a parallelogram structure 64 is articulated supporting a platform 7 on which one or more operators O can stand.

The platform 7 comprises a floor 71 and a railing 72 that define a space in which operator O can stand. The platform 71 is also equipped with a control console 8 for then controlling the movements of the lift 1 on the surface of the ground S using the motor unit 4, the deployment of the mast 6, and the pivoting of the parallelogram structure 64, using actuators that are not shown, such as electric or hydraulic cylinders. The console 8 is sometimes described as a control module.

An electronic control unit 9 is integrated into the motor unit 4 and connected to the console 8 by a wired connection (not shown), which makes it possible to convey the control orders from the console 8 to the unit 9.

As emerges from FIGS. 3 and 4, the console 8 includes a first module 81 called “left half-console” and a second module 82 called “right half-console”, which are each articulated on an upright 721, 722, respectively, of the railing 72 around a vertical axis Z81, Z82, respectively, as shown by arrows F81 and F82 in FIG. 4.

V8 denotes the space defined between the half-consoles 81 and 82 along the railing 72. The upper tube 723 of the railing 72 is coated with a sleeve 83 made from a flexible material, for example elastomer.

The left half-console 81 is equipped with a lever 811 of the “joystick” type, an emergency stop button 812 and several switches 813 using which the operator can send control orders to the unit 9. Likewise, the half-console 82 is equipped with a lever or “joystick” 821, an emergency stop button 822 and several switches 823.

Lighted indicators 814 and 824 are provided on the half-consoles 81 and 82, respectively. They allow the operator to obtain feedback on the orders he sends or on the activation of certain functions using the switches 813 and 823.

The half-consoles 81 and 82 are mounted on the railing 72 near its upper tube 723, with a distance d8, measured between the axes Z81 and Z82 along that tube, such that an operator wishing to use the console 8 can have his left hand surrounding the lever 811 and his right hand surrounding the lever 812 in a comfortable position, with the forearms parallel. In this position, the median axis Z0 of the operator's body is positioned in a median plane P8 relative to the axes Z81 and Z82 and perpendicular to the railing 72, in its zone comprised between those axes.

Thus, in the normal usage configuration, the median axis Z0 of the operator's body O is situated across from the space V8 in which the levers and buttons of the two half-consoles 81 and 82 are not situated.

Under these conditions, when the lift 1 moves in the direction of arrow F1 in FIG. 2 and when the operator O is struck from behind by a beam P, as shown in FIG. 3, the operator's body is pushed back toward the space V8, until it potentially comes into contact with the sleeve 83, without risk of injury with the levers and buttons 811, 812, 813 and equivalent.

The half-consoles 81 and 82 are articulated independently of one another on the uprights 721 and 722. This facilitates the configuration of the workstation based on the preferences and morphology of the operator O. This allows the half-consoles to orient themselves independently of one another when they are impacted by the operator's body or legs, in a variable direction that depends on the movement direction of the platform 7 relative to the beam P and/or the movements of the operator.

Furthermore, since the half-consoles 81 and 82 are respectively articulated around the axes Z81 and Z82, the fact that the operator is pushed toward the space V8 tends to separate those modules from one another by pivoting the half-console 81 to the left in FIG. 4 and the half-console 82 to the right in that figure.

Advantageously, an automatic emergency stop system can be provided in the form of a detector for detecting the angular position of one or the other or both half-consoles 81 and 82 around their axes Z81 and Z82. One such detector is shown in FIG. 4, for the half-console 81 only, with reference 85. When one of these half-consoles is completely folded down toward the outside, i.e., opposite the other half-console, it may be provided that this corresponds to a potentially dangerous situation where the operator O has been pushed back toward the space V8, as shown in FIG. 3, in which case a stop of the lift 1 is programmed under the action of the detectors 85 and equivalent.

The invention is shown in the case where the two half-consoles 81 and 82 are each articulated around a vertical axis. Alternatively, only one of these consoles may be pivotably mounted in this way, or even neither of them.

In the second embodiment of the invention shown in FIGS. 5 and 6, the elements similar to those of the first embodiment bear the same references. Below, we will only describe what differentiates this embodiment from the previous one.

In this embodiment, the console 8 comprises, in addition to the left half-console 81 and the right half-console 82, a central console 84 that bears indicators 844, while the levers or “joysticks” 811 and 821 and switches 813 and 823 are respectively provided on the half-consoles 81 and 82. An emergency stop button 822 is provided on the right half-console 82.

As in the first embodiment, a space V8 is defined situated along the upper tube 723 of the railing 72, between the half-consoles 81 and 82. The bracket 84 is positioned in this space V8.

Δ8 denotes a straight line parallel to the railing 72 and connecting the consoles 81 and 82. D8 denotes a horizontal direction perpendicular to the straight line Δ8. This direction D8 is parallel to the plane P8 defined as in the first embodiment.

L81 and L82 denote the lengths of the half-consoles 81 and 82 measured parallel to the direction D8. λ84 denotes the width of the bracket 84 measured parallel to that direction. The width £84 is smaller than the lengths L81 and L82. In other words, the space V8 is partially freed in front of the operator O when he stands in front of the console 8 in a position for using the buttons or levers 811, 821, 822, 813 and 823.

Advantageously, the indicators 844 are integrated into the upper face of the bracket 84, such that they do not protrude above that surface.

Thus, in case of an incident, as shown in FIG. 5, where the operator O is pushed toward the space V8, the operator O can bear against the bracket 84 without risk of injury as a result.

The bracket can be made from a flexible synthetic material or coated with such a material.

According to one advantageous aspect of the invention that is applicable to all of the embodiments, the height of the console 8 can be adjustable relative to the floor 71 of the platform 7. In the first embodiment, the height of the articulated means for mounting the half-consoles 81 and 82 on the vertical uprights 721 and 722 of the railing 72 can be adjustable. In the second embodiment, the height of the entire console 8 can be adjusted relative to the floor 71.

Irrespective of the embodiment, the space V8 in front of which the operator O stands when he uses the levers and buttons of the half-consoles 81 and 82 has no protruding lever or button. Thus, the risks of injury to the operator O, when he is pushed toward that space by the beam P in FIGS. 3 and 5, are decreased relative to the configuration of FIG. 1.

The invention is shown in the figures in the case where the lift is of the vertical telescoping mast type. It is also applicable to any other boom lift, in particular of the “scissor” or articulated mast type.

The technical features of the embodiments and their alternatives considered above may be combined with each other.

1. A boom lift comprising a frame equipped with means for moving on the surface of the ground, a platform, means for elevating the platform relative to the frame, and a console for controlling the movement means and/or elevation means from that platform, wherein the control console comprises two half-consoles each equipped with at least one control lever or button for controlling the lift manually and positioned on either side of an operator present on the platform in a position for using those levers or buttons with both of his hands, while the space positioned across from the position of the operator has no lever and control button.

2. The lift according to claim 1, wherein the half-consoles are mounted on the lift independently of one another.

3. The lift according to claim 2, wherein at least one half-console is mounted pivotably relative to the platform.

4. The lift according to claim 3, wherein the half-console is capable of pivoting around a vertical axis relative to the platform.

5. The lift according to claim 1, wherein the lift is equipped with at least one detector which, when the half-console abuts during pivoting, emits a signal to activate emergency stop means of the lift.

6. The lift according to claim 1, wherein the two half-consoles are connected to each other by a central bracket wherein the width of the central bracket, measured in a horizontal direction perpendicular to a straight line connecting the two half-consoles, is smaller than the size of those half-consoles in that direction.

7. The lift according to claim 6, wherein the central bracket faces the operator present on the platform in the position for using the levers or buttons of the half-consoles with both of his hands, and it is equipped with information devices with no protruding parts.

8. The lift according to claim 1, characterized in that wherein the half-consoles are mounted on a railing of the platform.

9. The lift according to claim 8, wherein the each half-console is mounted and articulated on a vertical upright of the railing.

10. The lift according to claim 1, characterized in that wherein the height of at least one of the half-consoles can be adjusted relative to the platform.

11. The lift according to claim 2, wherein both half-consoles are-mounted pivotably relative to the platform.
